(19) United States
(12) Patent Application Publication
(10) Pub. No.: US 2017/0024227 A1
(43) Pub. Date: Jan. 26, 2017

(54) A MOBILE ELECTRONIC DEVICE COOPERATIVE SYSTEM

(71) Applicant: HONDA MOTOR CO., LTD., Tokyo (JP)

(72) Inventor: Shinichi Akama, Wako-shi, Saitama (JP)

(73) Assignee: HONDA MOTOR CO., LTD., Tokyo (JP)

(21) Appl. No.: 15/039,508

(22) PCT Filed: Nov. 5, 2014
(86) PCT No.: PCT/JP14/05569

§ 371 Date: May 26, 2016

(30) Foreign Application Priority Data
Dec. 3, 2013 (JP) 2013-249810

(51) Int. Cl. G06F 9/44; G06F 3/14; G06F 3/0484

(52) U.S. Cl. CPC G06F 9/4445; G06F 3/04847; G06F 3/1423

(57) ABSTRACT

Therefore, there is a need for a mobile electronic device cooperative system that enables an on-board device utilize Web applications which use information from an external server on a Web browser of the mobile device. In accordance with the present invention, a mobile electronic device cooperative system comprises an on-board display device provided with a cooperative interface for connecting a display unit and an handling unit with a mobile electronic device, a Web browser that may work in a direct handling manner wherein the browser is controlled via CUI (graphic user interface) and also in an indirect handling manner wherein the browser is controlled via programming language, and a Web application server for providing Web applications that run on the Web browser. The mobile electronic device cooperative system performs an indirect handling by means of the programming language by displaying GUI of the Web browser via the cooperative interface on the on-board display device, wherein a pseudo (emulated) GUI is formed on the handling unit based on displayed contents and wherein operation of the pseudo GUI from the handling unit is output to the mobile electronic device.

### FIELD OF THE INVENTION

The present invention relates to a mobile electronic device cooperative system, on-board display device, and computer program for cooperative work, and in particular to a mobile electronic device cooperative system, on-board display device and computer program for use with a vehicle.

### BACKGROUND ART

Mobile devices have been used on vehicles in cooperation with on-board devices. In the prior art, a navigation system is known that cooperates with on-board devices and performs remote-control of the on-board devices by using the mobile device (patent document #1).

As the functionality of mobile devices improves, mobile devices are now used to communicate with an external server so as to visualize the contents on the screens of the mobile devices. Because the screen of the mobile device is relatively small, it would be good to use a screen of the on-board device having a larger size for display.

As various applications for mobile devices have been developed, some applications now require that they are made for respective on-board devices and need be distributed.

### PRIOR ART DOCUMENTS

International Publication WO2012/157014

### SUMMARY OF THE INVENTION

### Problems to be Solved by the Invention

Therefore, there is a need for a mobile electronic device cooperative system that enables an on-board device utilize Web applications which use information from an external server on a Web browser of the mobile device.

### Means for Resolving the Problems

In accordance with the present invention, a mobile electronic device cooperative system comprises an on-board display device provided with a cooperative interface for connecting a display unit and an handling unit with a mobile electronic device, a Web browser that may work in a direct handling manner wherein the browser is controlled via CUI (graphic user interface) and also in an indirect handling manner wherein the browser is controlled via programming language, and a Web application server for providing Web applications that run on the Web browser.

The mobile electronic device cooperative system performs an indirect handling by means of the programming language by displaying GUI of the Web browser via the cooperative interface on the on-board display device, wherein a pseudo (emulated) GUI is formed on the handling unit based on displayed contents and wherein operation of the pseudo GUI from the handling unit is output to the mobile electronic device.

According to an aspect of the invention, the mobile electronic device cooperative system, in the indirect handling, uses positional information of the operation of the pseudo GUT made with the handling unit as parameters.

According to another aspect of the invention, the mobile electronic device cooperative system, when manners of screen display are different for the direct handling and the indirect handling, controls the display unit so that it operates in the manner of direct handling.

According to another aspect of the invention, the electronic device cooperative system, in the indirect handling, when an on-board GUI having equivalent functions as the GUI of the Web browser is provided, forms a pseudo GUI utilizing the on-board GUI, and uses output of the on-board GUI as parameters.

The on-board display device in the present invention comprises a display unit, an handling unit, Web browser capable of performing a direct handling via GUI and an indirect handling by means of programming language, and a cooperative interface for connection with a mobile electronic device with a cooperative program.

The cooperative interface enables the indirect handling of the Web browser by means of programming language by displaying the GUI of the Web browser on the display unit, forming the pseudo (emulated) GUI in the handling unit based on the contents of the display, operation of the pseudo GUI producing output from the handling unit to the mobile electronic device.

The cooperative program in the present invention is used in the cooperative interface that connects the on-board display device and the mobile electronic device and enables the direct handling via the GUI and the indirect handling by means of programming language.

The cooperative program, via the cooperative interface, performs the steps of displaying in the display unit GUI of the Web browser, forming a pseudo GUI in the operative unit based on the contents of the display carrying out indirect handling of the Web browser by means of programming language based on operation of the pseudo GUI.

### BRIEF DESCRIPTION OF THE DRAWINGS

FIG. 1 is a block diagram illustrating an overall structure of the mobile electronic device cooperative system according to one embodiment of the present invention.

FIG. 2 is a block diagram illustrating a conceptual structure of the mobile electronic device according to one embodiment of the present invention.

FIG. 3 is a block diagram illustrating a conceptual structure of the cooperative program of the mobile electronic device.

FIG. 4 is a block diagram illustrating a conceptual structure of the on-board display device.

FIG. 5 is a chart illustrating coordinates of a touch-panel.

FIG. 6 is a flow chart illustrating operational steps of the mobile electronic device cooperative system according to one embodiment of the present invention.

FIG. 7 is a chart illustrating a screen of a Web application displayed on the on-board display device.

Embodiments of the present inventions will be described with reference to the drawings.

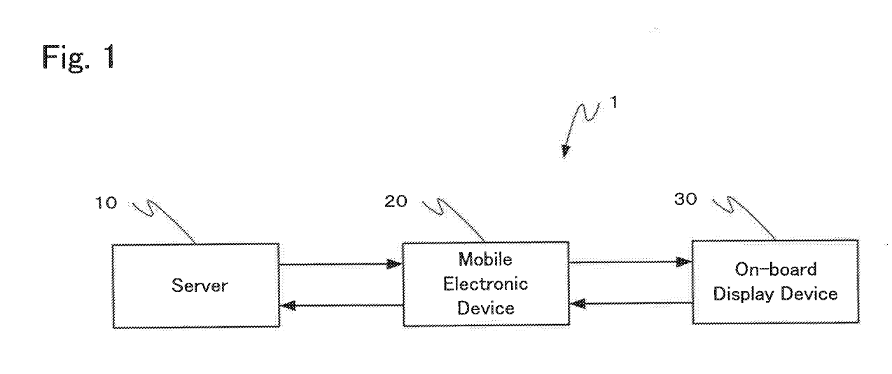

FIG. 1 is a block diagram illustrating an overall composition of the mobile electronic device cooperative system according to one embodiment of the present invention. Mobile electronic device cooperative system 1 comprises a server 10, mobile electronic device 20, and on-board display device 30.

Server 10 works as a Web server capable of providing Web service. Web service includes for example social networking service (SNS) and map service. Server 10 also distributes various applications and programs for use with vehicles.

Server 10 may be a single server or may be group of a plurality of servers. In case of a group of a plurality of servers, communication among the server 10 may be performed by wired communication or by wireless communication.

Mobile electronic device 20 is a mobile device that may be carried into a vehicle and be used in the vehicle, such as a multi-function mobile telephone device known as a smart-phone.

On-board display device 30 is mounted in a vehicle and includes a display unit and an handling unit that is an input means for use by the users such as a touch-panel.

Server 10 and mobile electronic device 20 exchange information with each other over various wireless communications.

Mobile electronic device 20 and on-board display device 30 exchange information with each other with a wired communication by means of USB (Universal Serial Bus) or with a wireless communication such as Bluetooth (trademark). Mobile electronic device 20 transmits information such as display signals to on-board display device 30. On-board display device 30 sends information such as operation signals to mobile electronic device 20.

Transmission of contents described in HTML (Hyper-Text Markup Language) between server 10 and mobile electronic device 20 is made using a communication protocol such as HTTP (Hyper-Text Transfer Protocol).

Generally, Web applications that are used through Web browsers are widely known. As development and performance environment for the Web applications matures, there has been provided an environment called rich client. In order to achieve a Web-based rich client in cooperation with on-board display device 30, the Web browser provided in mobile electronic device 20 is to be used, and therefore there is a need that on-board display device 30 is capable of sufficiently control the Web browser.

However, the hardware and the operating system (OS) of mobile electronic device 20 may not allow or restrict devices other than the mobile electronic device 20 performing remote control of the Web browser on the basis of security reasons or functional restrictions.

In one embodiment of the present invention, under such restricted environment, the screen of mobile electronic device 20 is mirrored on the display unit of on-board display device 30, the Web browser of mobile electronic device 20 is operated by internal programming (in on-board display device 30) so that operation on on-board display device 30 may emulate operation of the Web browser of mobile electronic device 20.

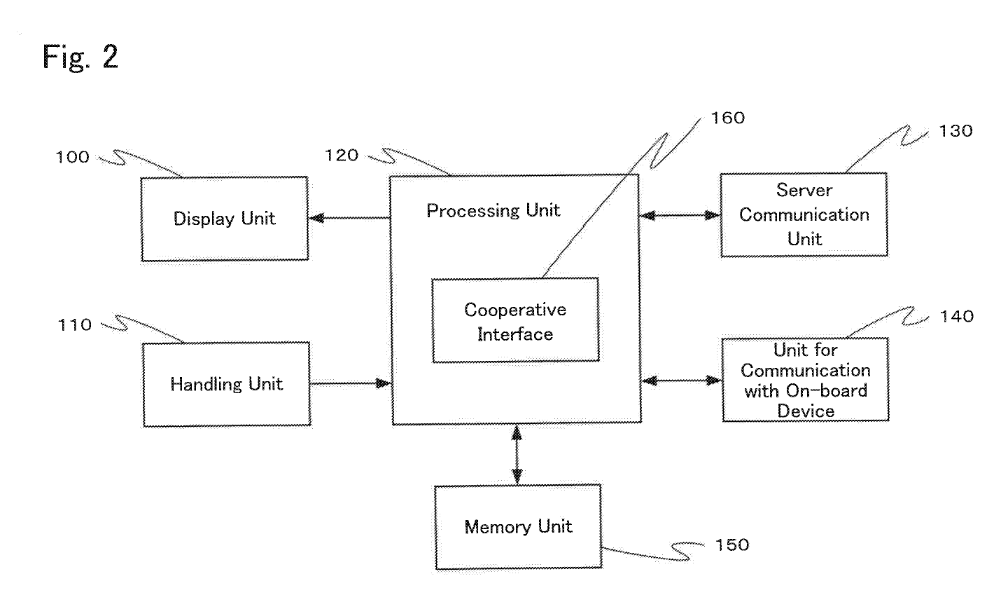

First, mobile electronic device 20 will be described. FIG. 2 is a block diagram illustrating conceptual structure of mobile electronic device. Mobile electronic device 20 comprises display unit 100, handling unit 110, processing unit 120, unit 130 for communication with a server unit 140 for communication with on-board display device and memory unit 150.

Display unit 100 includes a display such as a LCD (liquid crystal display) and organic electroluminescence display (organic EL) for displaying graphics and text message. Handling unit 110 is an input device for use by a user for entering information and instructions to mobile electronic device 20, and may be a touch-panel provided on the display screen of display unit 100. Hereinafter, handling unit 110 is described as a touch-panel mounted on the full surface of the display screen of display unit 100.

Unit 130 for communication with a server performs communication with external server 10 via for example wireless network. Unit 140 for communication with on-board display device performs communication of information with on-board display device 30 via wired communication such as USB or via wireless communication such as Bluetooth.

Processing unit 120 is a computer provided with a processor such as CPU (Central Processing Unit), a memory including ROM (Read Only Memory) storing computer programs and RAM (Random Access Memory) for temporarily storing data, and cooperative interface 160. Cooperative interface 160 may be formed by processing unit 120 executing a computer program, which may be stored in a computer readable storage media. Cooperative interface 160 may also be composed as a dedicated hardware comprising one or more electric components.

Memory unit 150 may comprise a non-volatile memory device or combination of a non-volatile memory device and a volatile memory device. Memory unit 150 stores various application programs as well as working data which processing unit 120 produces and/or retrieve during its performance.

Now, cooperative program to be executed by cooperative interface 160 will be described.

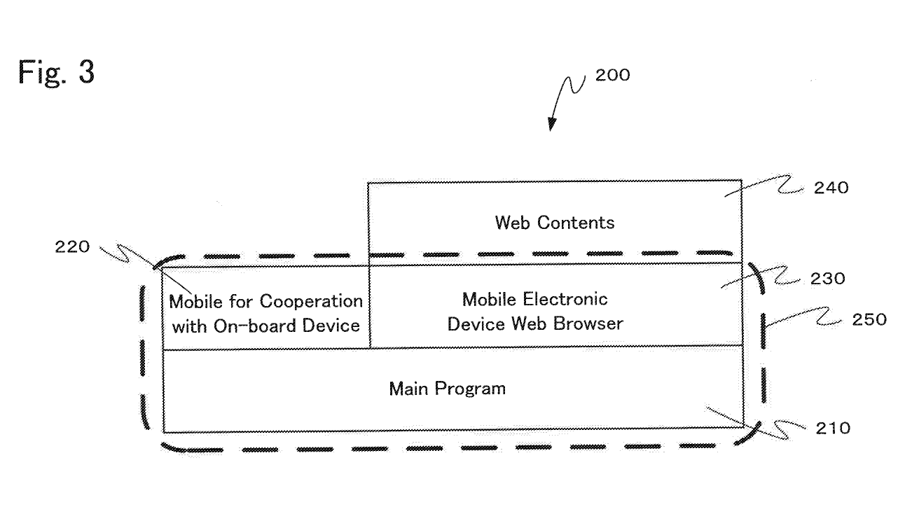

FIG. 3 is a block diagram illustrating a conceptual structure of the cooperative program of the mobile electronic device. Cooperative program 200 comprises main program 210, module 220 for cooperation with on-board device, mobile electronic device Web browser 230, and Web contents.

Main program 210 is provided at the lowest level of cooperative program 200. Main program 210 is a program that is a basis for using module 220 for cooperation with on-board device and Web browser 230.

Cooperative module 220 is located in a layer above main program 210 and performs cooperative process relative to on-board display device 30. Cooperative module 220 handles and processes handling signals and display signals for communication with on-board display device 30. Cooperative module 220 performs transmission and reception relative to on-board display device 30.

Mobile electronic device Web browser 230 is located in the layer above main program 210. Web browser 230 fetches Web browser functions from the OS of mobile electronic device 20. Web browser 230 communicates with server 10 and receives Web contents and sends requests.

Web contents 240 are located in the layer above Web browser 230. Web contents are contents of such formats as HTML and JPEG (Joint Photographic Experts Group).

Mobile electronic device application 250 includes main program 210, module 220 for cooperation with on-board device, mobile electronic device Web browser 230. Application 250 enables on-board display device 30 to display and handle Web browser.

Module 220 for cooperation with on-board device may be supplied by server 10. Server 10 stores respective modules for cooperation with on-board device corresponding to individual on-board display devices prepared for various types of vehicles. Web applications may be added, modified or extended in server 10 by the manufacturer of the on-board display device. In this manner, Web application may be updated and distributed to mobile electronic device 20 quickly so that the Web application may catch up with development of mobile electronic device 20.

The users may access server 10 in order to customize display screen according to the user's preference.

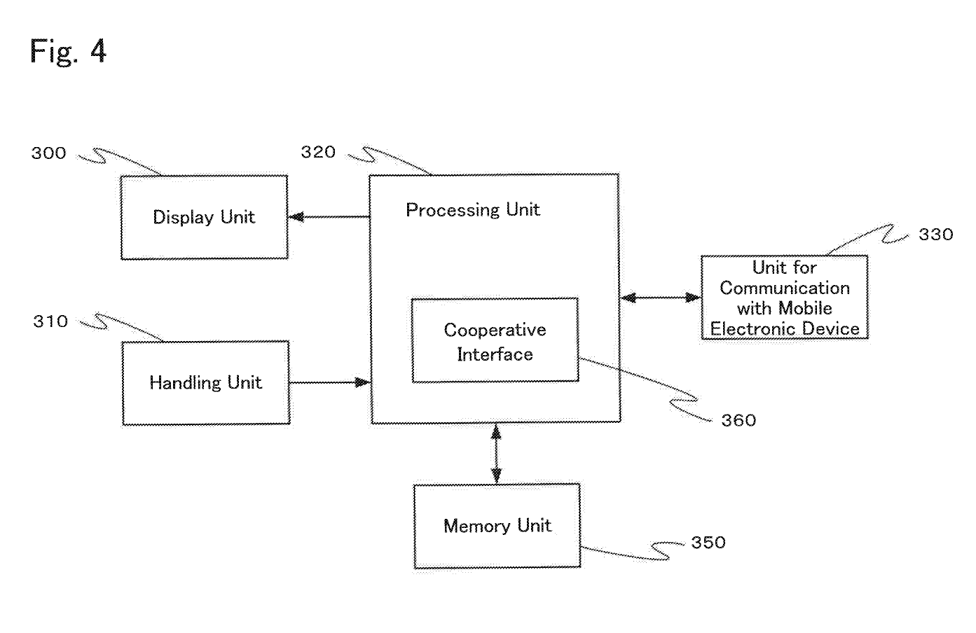

On-board display device 30 will now be described with reference to FIG. 4, a block diagram illustrating conceptual structure of the on-board display device.

On-board display device 30 includes display unit 300, handling unit 310, processing unit 320, communication unit 330 and memory unit 350.

Display unit 300 includes a display that may be a liquid crystal display or an organic EL display for displaying graphics and text messages.

Handling unit 310 is an input device to be used by a user for entering information and commands to on-board display device 30. Handling unit 310 can be a touch-panel provided on the display screen of display unit 300. Hereinafter, handling unit 310 will he described as a touch-panel provided on the surface of the display screen of display unit 300.

The touch-panel detects the position that a user touched by means of coordinates in vertical and horizontal axes.

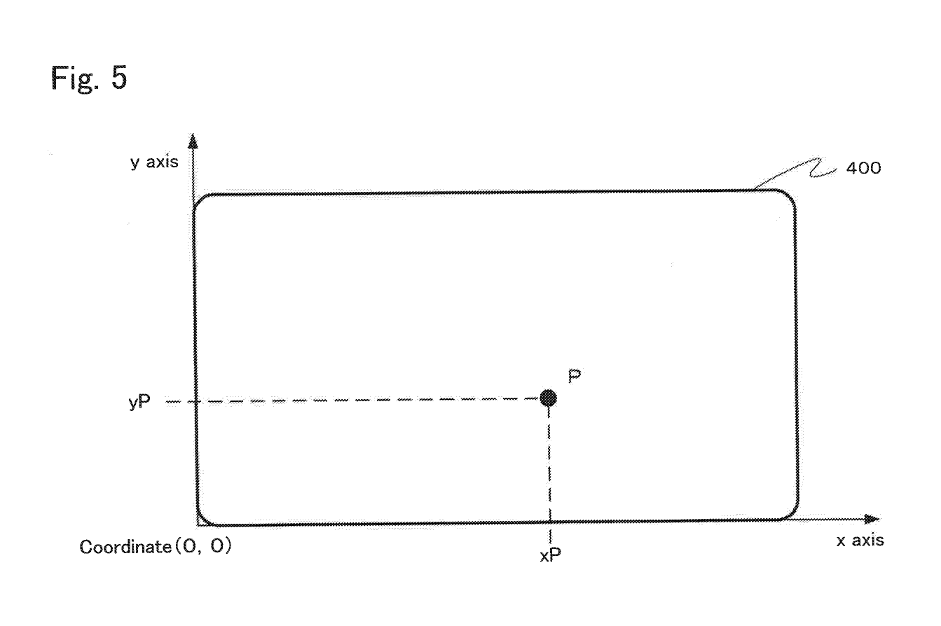

FIG. 5 illustrates the coordinates of the touch-panel. When a user touches point P on touch-panel 400, a position of coordinates (xP, yP) is detected, xP being the position on x coordinate and yP being the position on y coordinate. This coordinates may indicate an absolute position on touch-panel 400 or may indicate a relative position.

Unit 330 for communication with mobile electronic device may communicate with mobile electronic device 20 by wired communication with USB or by wireless communication using for example Bluetooth.

Processing unit 320 is a computer having a processor such as a CPU, and a memory including a ROM storing computer programs and a RAM for temporarily storing data. Processing unit 320 includes cooperative interface 360. Cooperative interface 360 may be formed by processing unit 320 executing a computer program, which may be stored in a computer readable memory medium.

Cooperative interface 320 is an interface for cooperation with mobile electronic device 20 and may be thrilled by executing a computer program or may be composed by a dedicated hardware comprising one or more electric components.

Memory unit 350 may be formed by a non-volatile memory device or a combination of one or more non-volatile memory devices and one or more volatile memory devices, which may include semiconductor memory or a hard-disk drive (HDD).

Cooperation of mobile electronic device 20 and on-board display device will now be described. Cooperative interface 160 of mobile electronic device 20 processes information entered with on-board display device 30 and transmits information to be displayed on on-board display device.

As a handling process for information to be displayed on on-board display device, cooperative interface 160 (mobile electronic device 20) transmits to on-board display device 30 screens that are displayed on the display of mobile electronic device 20. Display unit 300 of on-board display device 30 differs from display unit 100 of mobile electronic device, but the same contents are displayed.

Cooperative interface 360 of on-board display device 30 displays Web browser screens that are received from mobile electronic device 20. Thus, display on display unit 300 of on-board display device 30 is tied with display on display unit 100 of mobile electronic device 20.

As a handling process for information entered in on-board display device 30, cooperative interface 160 (of mobile electronic device 20) converts the information that is entered in handling unit 310 of on-board display device 30 into information of the form that is used in handling unit 110 of mobile electronic device 20.

Because some applications (of mobile electronic device 20) do not accept handling by other means than handling unit 110 of mobile electronic device 20, information entered from handling unit 310 of on-board display device 30 is converted such that GUI (Graphic User Interface) of mobile electronic device 20 is partially emulated, thus the handling looks as if it is handling GUI of mobile electronic device 20.

Such a GUI is called pseudo (emulated) GUI. The pseudo GUI is an emulation of the GUI incorporate in mobile electronic device 20. In the present embodiment, handling unit 310 of on-board display device 30 is used as if it is handling unit 110 of mobile electronic device 20.

To handle Web applications with the use of the pseudo GUI, conversion of information is required as the process differs from the case where GUI of mobile electronic device is directly used to handle the applications. In contrast to the direct handling where GUI of mobile electronic device is directly used, the handling from mobile electronic device 30 may be called an indirect handling.

Cooperative interface 160 (mobile electronic device 20) converts by means of programming language the information entered from handling unit 310 of on-board display device 30 to enable the indirect handling from on-board display device 30. In this manner, the information entered at on-board display device is made as if it is entered at handling unit 110 of mobile electronic device 20.

For example, when touch operation (wherein the user touches the touch-panel) is made at handling unit 310 of on-board display device 30, cooperative interface 360 of on-board display device 30 obtains and transmits to mobile electronic device 20 current x coordinate position, y coordinate position, x and y coordinate position immediately preceding the current handling, and time-stamp.

Cooperative interface 160 (mobile electronic device 20) uses the received coordinate positional information as parameters to convert the information into touch-panel information that may be transferred to JavaScript (trademark), thus reflecting such pseudo GUI into Web applications as the indirect handling.

In case handling unit 310 of on-board display device 30 has other input means than the touch-panel such as a dedicated switch or a mouse, there may be internal operations that are not displayed on display unit 300. In such a case, handling of handling unit 310 by the user may be converted to enable the indirect handling by the programming language.

Even in the case that applications only accept handling from handling unit 110 of mobile electronic device 20, by means of the indirect handling using the pseudo GUI, absolute/relative positions of the handling input to handling unit 310 of on-board display device may be used as input of positions to mobile electronic device 20. This enables to employ a number of applications that are provided with GUIs operating on the basis of positions.

On the other hand, cooperative interface 160 (mobile electronic device 20) is capable of performing direct handling through GUI with the use of handling unit 110 of mobile electronic device 20.

In case manners of screen display differs between the direct handling and the indirect handling, display unit 300 (on-board display device 30) is controlled such that its screen display matches the screen display of the direct handling.

In the direct handling, the portions selected by the user may be highlighted in the screen display, a password entered may be masked, or otherwise screen display may be modified for some purposes. On the other hand, in the indirect handling, such modifications may not be made (by on-board display device 30) and entered items are immediately displayed without modification. Users may feel uncomfortable about such differences.

Accordingly, in case the direct handling and the indirect handling involve different screen displays, display unit 300 (on-board display device 30) may be modified to present a similar screen display as that of the direct handling, whereby uncomfortable feelings with the remote control (indirect handling) from on-board display device 30 is reduced or eliminated.

Whether or not the screen displays by the direct handling and the indirect handling differ from each other may be determined by mobile electronic device 20 making an inquiry to on-board display device 30. This determination may be made based on the information stored in mobile electronic device 20 for each one of various types of on-board display devices 30.

When a GUI for on-board display device 30 is available that provides similar function as that of mobile electronic device 20, such GUI used on on-board display device 30 will provide a better operation and better response for graphing and handling.

Thus, in the indirect handling, in case an on-board GUI having equivalent functions as the GUI of Web browser is available, such on-board GUI will be used to provide a pseudo GUI and the outputs from the on-board GUI are used as parameters. Also, GUIs of on-board display device 30 and mobile electronic device 20 may be compared to provide a suitable GUI. For example, software keyboard on the on-board side for entering characters and fetching of a list for selecting date and time correspond to the functions of such an operation.

On-board display device 30 may provide a safe HMI (Human Machine Interface) designed by the manufacturer of on-board display device 30 which is easy to use.

Whether or not the on-board display device has an on-board GUI that provides similar functions as the Web browser used with mobile electronic device 20 may be determined by mobile electronic device 20 inquiring from on-board display device 30. This determination may be made based on the information stored in mobile electronic device 20 for each one of various types of on-board display devices 20.

Mobile electronic device 20 uses applications conforming to Web applications that run on Web browser of the mobile electronic device. Thus, the system may support new contents without modifying the software of on-board display device 30.

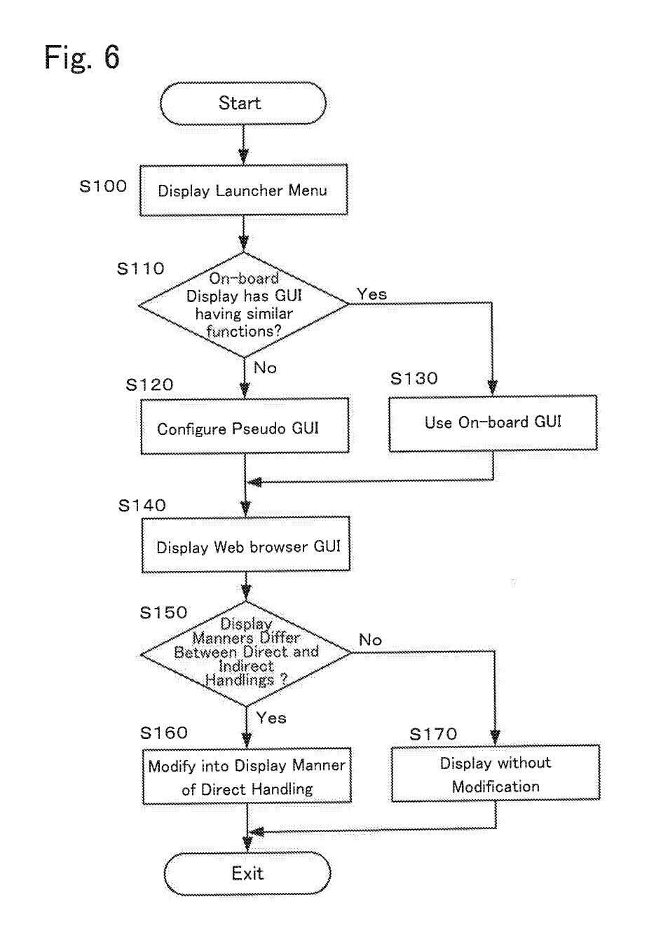

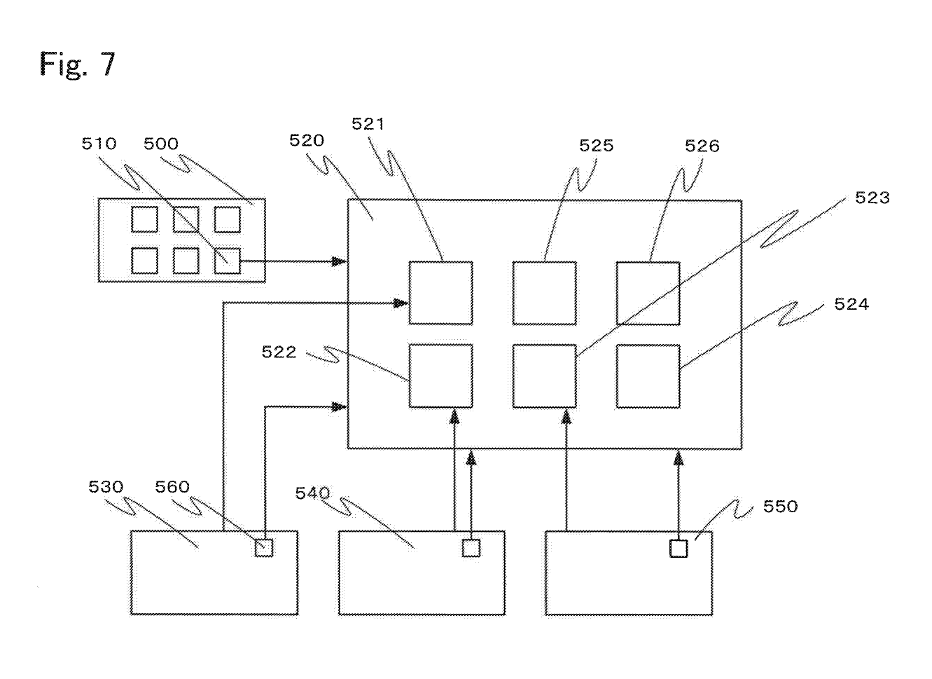

Operational procedure of a mobile electronic device cooperative system will now be described with reference to FIGS. 6 and 7.

FIG. 6 is a flow chart showing the operational procedure of a mobile electronic device cooperative system according to an embodiment of the present invention.

FIG. 7 illustrates a Web application screen displayed on an on-board display device.

In the initial step S100, in display unit 300 of on-board display device 30 launcher menu 500 according to an built-in software of mobile electronic device 20 is displayed.

Launcher menu 500 presents in terms of icons a listing of files and programs that are registered beforehand. Launcher menu 500 includes various icons. When a user touches one of the icons 510 with handling unit 310, the process moves to step S110.

In step S110, determination is made as to whether on-board display device 30 has on-board GUI having the same or similar functions to the GUI of the Web browser. If negative, the process moves to step S120, and if positive, the process moves to S130.

In step S120, cooperative interface 360 (on-board display device 30) is configured to form a pseudo GUI. Process moves to step S140.

In step S130, cooperative interface 360 is configured to form a pseudo GUI using the on-board GUI. Process moves to step S140.

In step S140, based on the position touched with handling unit 310 an application corresponding to icon 510 is identified and activated. Display unit 300 displays Web browser screen 520 of the application. Screen 520 includes icons 521, 522, 523, 524, 525, and 526. That is, display unit 300 displays GUI of the Web browser.

In case the Web browser of the activated application does not accept handlings other than those made by handling unit 110 of mobile electronic device 20, handlings made with handling unit 310 (on-board display device 30) become entries to the pseudo GUI, which is formed with a combination of display and handling.

When the user clicks icon 521, the positional information for icon 521 is output to mobile electronic device 20 as a parameter. The process moves to step S150.

In step S150, determination is made as to whether screen display manners differ between the direct handling and the indirect handling. If the screen display manners differ, the process moves to step S160, otherwise the process moves to step S170.

In step S160, display unit 300 (on-board display device 30) is adjusted to produce screen display corresponding to the display manner of the direct handling. And the process exits the flow.

In step S170, no substantial adjustment is made, and the process exits the flow.

In step S140, when for example icon 521 is clicked, screen 530 for the contents of Web application relating to location is displayed in step S160 or S170. Similarly, when a user clicks icon 522, screen 540 for the contents of Web application relating to navigation is displayed, and when icon 523 is clicked, screen 550 for the contents of Web application relating to messages is displayed.

On the upper parts of screens 530, 540, and 550, icon 560 indicating the Web applications in the initial screen 520 is displayed so that layer relationship may be recognized.

This way on-board display device 30 is now provided with functions of a Web browser of a personal computer including for example functions to see weather forecast, retrieve gourmet guide and to watch maps through the browser of mobile electronic device 20.

In the above description, cooperative program 200 was described to be provided in mobile electronic device 20, but a portion or all of cooperative program 200 may be provided in on-board display device 30 in another embodiment.

In the latter case, cooperative interface 360 of on-board display device 30 performs the direct and indirect handlings, and on-board display device 30 directly sends a remote control program to the Web browser of mobile electronic device 20.

Alternatively, cooperative program 200 may be distributed from server 10 to on-board display device 30 through mobile electronic device 20.

Mobile electronic device cooperative system according to the present embodiment, the system comprises an on-board display device having a cooperative interface for connecting a display unit and a handling unit to a mobile electronic device, Web browser capable of direct handling through GUI and indirect handling through programming language, mobile electronic device having cooperative program, and Web application server providing Web applications that utilize the Web browser.

The mobile electronic device cooperative system performs the indirect handling of the Web browser through the programming language by displaying GUI of the Web browser on the display unit (of the on-board display device), and forming a pseudo GUI on the handling unit, the handling unit transmitting outputs of operations on the pseudo GUI to the mobile electronic device.

Thus, the GUI can be handled from a device of a different nature through the Web browser while utilizing general versatility of server-based Web applications. Where remote control is prohibited for security reasons, or where remote control between devices of different nature is difficult to perform due to such differences as accuracy of touch sensors, such remote control is enabled (according to the present invention) by separating display and handling.

As server-based Web applications are used, GUI may vary depending on the contents to be distributed. But, as the Web browser can be handled by the programming language alone that is prepared beforehand for the indirect handling, man-hours for development of the applications would be reduced.

Here, “prepared beforehand” means that the Web browser is made to enable handling by programming. For example, a regular Web browser is designed to be capable of executing and working with script languages and/or other languages that are programming languages for the indirect handling.

According to the present embodiment, the mobile electronic device cooperative system may suitably use Web-based rich clients.

The present invention is not intended to be limited to the embodiments described above. Various modifications may be made without departing the scope of the present invention.

### DESCRIPTION OF THE REFERENCE NUMBERS

500 Launcher Menu
510, 521-526, 560 Icon
520, 530, 540, 550 Screen

What is claimed is:

1. A mobile electronic device cooperative system comprising:
an on-board display device having a cooperative interface for connecting a display unit and a handling unit to a mobile electronic device;
a mobile electronic device provided with Web browser capable of a direct handling through GUI and an indirect handling by means of programming language, and provided with a cooperative program; and
Web application server providing Web applications that utilize the Web browser;
wherein via the cooperative interface the mobile electronic device cooperative system is configured to:
display GUI of the Web browser on the display unit,
form a pseudo GUI on the handling unit based on the contents of the display, and
supply output of handling of the pseudo GUI from the handling unit to the mobile electronic device, whereby the indirect handling of the Web browser by means of the programming language is performed.

2. The system of claim 1, wherein in the indirect handling, positional information of handling of the pseudo GUI with the handling unit is used as parameters.

3. The system of claim 1, wherein when the screen display manners differ between the direct handling and the indirect handling, the system controls the display unit to display with the screen display manner of the direct handling.

4. The system of claim 1, wherein in the indirect handling, if the on-board display device is provided with an on-board GUI having equivalent function as the GUI of the Web browser, the system is configured to form the pseudo GUI using the on-board GUI and to use output of the on-board GUI as parameters.

5. An on-board display device comprising:
a display unit;
a handling unit; and
a cooperative interface for connecting the display unit and the handling unit to a mobile electronic device provided with Web browser capable of a direct handling through GUI and an indirect handling by means of programming language;
wherein the cooperative interface is configured to;
display GUI of the Web browser on the display unit,
form a pseudo GUI on the handling unit based on the contents of the display, and
supply output of handling of the pseudo GUI from the handling unit to the mobile electronic device, whereby the indirect handling of the Web browser by means of the programming language is performed.

6. The on-board display device of claim 5, wherein in the indirect handling, positional information of handling of the pseudo GUI with the handling unit is used as parameters.

7. The on-board display device of claim 5, wherein when the screen display manners differ between the direct handling and the indirect handling, the system controls the display unit to display with the screen display manner of the direct handling.

8. The on-board display device of claim 5, wherein in the indirect handling, if the on-board display device is provided with an on-board GUI having equivalent function as the GUI of the Web browser, the system is configured to form the pseudo GUI using the on-board GUI and to use output of the on-board GUI as parameters.

9. A cooperative program for use in a cooperative interface for connecting an on-hoard display device and a mobile electronic device, the cooperative interface capable of a direct handling through GUI and an indirect handling by means of programming language, the program via the cooperative interface performs the steps of:
displaying GUI of the Web browser on the display unit,
forming a pseudo GUI on the handling unit based on the contents of the display, and
supplying output of handling of the pseudo GUI from the handling unit to the mobile electronic device, whereby the indirect handling of the Web browser by means of the programming language is performed.

10. The program of claim 9, wherein in the indirect handling, positional information of handling of the pseudo GUI with the handling unit is used as parameters.

11. The program of claim 9, wherein when the screen display manners differ between the direct handling and the indirect handling, the system controls the display unit to display with the screen display manner of the direct handling.

12. The program of claim 9, wherein in the indirect handling, if the on-board display device is provided with an on-board GUI having equivalent function as the GUI of the Web browser, the system is configured to form the pseudo GUI using the on-board GUI and to use output of the on-board GUI as parameters.
